(19) United States
(12) Patent Application Publication
(10) Pub. No.: US 2005/0141590 A1
(43) Pub. Date: Jun. 30, 2005

(54) Sensor for measuring water temperature

(76) Inventor: Kyung-Suk Kong, Busan (KR)

Correspondence Address: JORDAN AND HAMBURG LLP, 122 EAST 42ND STREET, SUITE 4000, NEW YORK, NY, 10168, US

(21) Appl. No.: 11/020,460

(22) Filed: Dec. 23, 2004

(30) Foreign Application Priority Data
Dec. 24, 2003 (KR) 10-2003-96305

(51) Int. Cl. G01K 13/00

(52) U.S. Cl. 374/148

(57) ABSTRACT

A sensor for measuring water temperature is capable of completely preventing a temperature-sensing sensor from being contacted with the moisture and of delaying a time interval of external temperature transmitted to the temperature-sensing sensor via a lead wire so that the external temperature cannot directly affect the temperature-sensing sensor. The sensor is capable of minimizing a breakdown of the temperature-sensing sensor due to various causes, is capable of providing a complete measurement of water temperature due to operation of the temperature-sensing sensor, and is capable of ensuring an effective use of some device such as various experimental devices or heat exchangers in which a process for measuring water temperature and a control therefore must be precisely performed. The temperature-sensing sensor is fixedly installed and is connected with the lead wire via an electric wire in a water sensing portion, which is formed at a front portion of a pipe-shaped body, together with a filing material, in which the lead wire to be connected with the temperature-sensing sensor is disposed and wound in a lead wire inserting space formed at a rear portion in the case in a tortuous manner so that a long length lead wire can be inserted into the case.

### BACKGROUND OF THE INVENTION

1. Field of the Invention

The present invention relates to a water temperature sensor, and more particularly to a sensor for measuring water temperature capable of completely preventing a temperature-sensing sensor from being contacted with the moisture and of delaying a time interval of external temperature transmitted to the temperature-sensing sensor via a lead wire so that the external temperature cannot directly affect the temperature-sensing sensor, which is capable of minimizing a breakdown of the temperature-sensing sensor due to various causes, which is capable of providing a complete measurement of water temperature due to operation of the temperature-sensing sensor, which is capable of ensuring an effective use of some device such as various experimental devices or heat exchangers in which a process for measuring water temperature and a control therefore must be precisely performed, by fixedly installing the temperature-sensing sensor to be connected with the lead wire via an electric wire in a water sensing portion, which is formed at a front portion of a pipe-shaped body, together with a filing material, in which the lead wire to be connected with the temperature-sensing sensor is disposed and wound in a lead wire inserting space formed at a rear portion in the case either in a zigzag manner or in a spiral manner so that a long length lead wire can be inserted into the case.

2. Description of the Prior Art

Generally, many kinds of temperature responsive sensing devices such as a diode, a platinum and a thermistor, which has a proper specific resistance and a proper temperature coefficient and is produced by mixing and then sintering one or more oxides selected from a group consisting of cobalt oxide, copper oxide, manganese oxide, ferrous oxide, nickel oxide, titanium oxide and unavoidable impurities, have been used in a temperature-sensing sensor. Since this temperature-sensing sensor has a very small heat capacity and provides a sudden resistance change due to a minute temperature change, it is widely used in equipments for measuring a temperature or devices for controlling change of the temperature.

When a user wants to measure water temperature by using the temperature-sensing sensor as described above, he or she makes the temperature-sensing sensor to be connected with the lead wire and the electric wire. Thereafter, the user makes it to be inserted into a device in which a measurement of water temperature is performed after sealing a connecting portion between the temperature-sensing sensor and the lead wire with a waterproof material. However, one problem with the conventional the temperature-sensing sensor is that the waterproof performance of the sealing part is too bad and therefore the temperature-sensing sensor sensitive to the moisture may be easily broken down.

A variety of endeavors for solving this problem have been proposed. One approach, a cap made of stainless steel that is a corrosion resistant alloy or a cap made by injection-molding an acrylonitrile butadiene styrene resin for enclosing the temperature-sensing sensor has been proposed. At this time, a front end of the casing is inserted into the device requiring the measurement of water temperature and a rear end is engaged with a wall surface of the device.

While the temperature-sensing sensor according to the prior art as described above can solve the problem relative to the waterproof of the connecting portion by sealing the temperature-sensing sensor at a casing with the aid of the cap, it has not been possible or practical to fix the cap made of stainless steel onto the temperature-sensing sensor and the lead wire so as to prevent a circuit of the temperature-sensing sensor from short-circuit. Furthermore, a space may be created between the temperature-sensing sensor and the cap during connection of the temperature-sensing sensor with the lead wire via the electric wire. Alternatively, in the cap made by injection-molding an acrylonitrile butadiene styrene resin, it has not been possible or practical to solve the problem that the electric wire for connecting the temperature-sensing sensor with the lead wire may easily short-circuit due to an injection pressure during injection-molding the cap together with the lead wire. Although various endeavors and a large labor time are required to manufacture the sensor for measuring water temperature, many of inferior goods may be produced and the productivity of the temperature-sensing sensor highly deteriorates.

One of these temperature-sensing sensors is disclosed in Japan Laid-Open Patent Publication No. Peyong1-191025 (Date of Publication: Aug. 1, 1998). In this temperature-sensing sensor, a sensor having a length of about 50˜100 mm is inserted into the device requiring the measurement of water temperature. When the temperature-sensing sensor is installed in the device, various filing material enclose the temperature-sensing sensor so that a heat generated at a position adjacent to the temperature-sensing sensor is slowly transmitted to the temperature-sensing sensor for a long time. However, one problem with this conventional the temperature-sensing sensor is that an external temperature is rapidly transmitted to the temperature-sensing sensor through the lead wire due to the temperature difference of about 50˜80° C. generated between a temperature measuring part such as a heat exchanger and the outside thereof. In other words, since the external temperature is rapidly transmitted through the lead wire to the temperature-sensing sensor and then it affects to the temperature-sensing sensor before it senses the external temperature, it is impossible to exactly measure the water temperature by using the temperature-sensing sensor. In order to solve this problem, it is required to install the lead wire having a length of about 500˜1,000 mm into the device, which requires the measurement of water temperature. However, it has not been possible or practical to install the long length lead wire due to limitation of use an interior space of the device and the necessity for preventing the temperature-sensing sensor from being contacted with the moisture.

Accordingly, if the temperature-sensing sensor according to the prior art is used in various experimental devices or heat exchangers, it is frequently broken down due to the fail of waterproof between the temperature-sensing sensor and the devices and the external heat transmitted through the lead wire to the temperature-sensing sensor. Furthermore, the reliability of various experimental equipments or heat exchangers deteriorates due to incomplete measurement of the water temperature. In addition, measuring equipments or the heat exchanging equipments may be broken down due to erroneous operation of the temperature-sensing sensor. Therefore, it is required to develop an improved sensor capable of effectively preventing the external temperature from being transmitted through the lead wire to the temperature-sensing sensor and of providing the temperature-sensing sensor with a complete waterproof.

### SUMMARY OF THE INVENTION

Therefore, the present invention has been made in view of the above-mentioned problems, and it is an object of the present invention to provide a sensor for measuring water temperature capable of completely preventing a temperature-sensing sensor from being contacted with the moisture and of delaying a time interval of external temperature transmitted to the temperature-sensing sensor via a lead wire so that the external temperature cannot directly affect the temperature-sensing sensor, which is capable of minimizing a breakdown of the temperature-sensing sensor due to various causes, which is capable of providing a complete measurement of water temperature due to operation of the temperature-sensing sensor, which is capable of ensuring an effective use of some device such as various experimental devices or heat exchangers in which a process for measuring water temperature and a control therefore must be precisely performed, by fixedly installing the temperature-sensing sensor to be connected with the lead wire via an electric wire in a water sensing portion, which is formed at a front portion of a pipe-shaped body, together with a filing material, in which the lead wire to be connected with the temperature-sensing sensor is disposed and wound in a lead wire inserting space formed at a rear portion in the case either in a zigzag manner or in a spiral manner so that a long length lead wire can be inserted into the case.

According to the present invention, there is provided a sensor for measuring water temperature, which includes a water temperature sensing part formed at a front portion of a case having a pipe-shaped body, and an engaging portion protruding from a rear circumferential edge of the case, in which a temperature-sensing sensor is installed in the water temperature sensing part and is connected with a lead wire via an electric wire, in which a rear terminal portion of the lead wire extends through a rear cover to the outside of the case, characterized in that: a slanted shoulder portion projects from the front portion of the case to the temperature-sensing part, in which the temperature-sensing part projects from the shoulder portion toward the front portion of the case and has a predetermined diameter smaller than that of the pipe-shaped body of the case, wherein the temperature-sensing sensor is fixedly installed in the water temperature sensing part by means of a filing material charged between the temperature-sensing part and the shoulder portion, wherein a lead wire inserting space is created at the rear portion of the pipe-shaped body of the case, in which the lead wire to be connected with the temperature-sensing sensor has a length of 500˜1,000 mm and is arranged in the lead wire inserting space either in a zigzag manner or in a spiral manner.

Preferably, the engaging portion of the case comprises a screw-thread connecting portion.

### BRIEF DESCRIPTION OF THE DRAWINGS

The above object and other characteristics and advantages of the present invention will become more apparent by describing in detail-preferred embodiments thereof with reference to the attached drawings, in which:

FIGS. 1A and 1B are side sectional views of a sensor for measuring water temperature according to a preferred first embodiment of the present invention;

FIGS. 2A and 2B are side sectional views of a sensor for measuring water temperature according to a preferred second embodiment of the present invention; and

FIGS. 3 and 4 show use of the sensor for measuring water temperature according to the present invention.

### DETAILED DESCRIPTION OF THE INVENTION

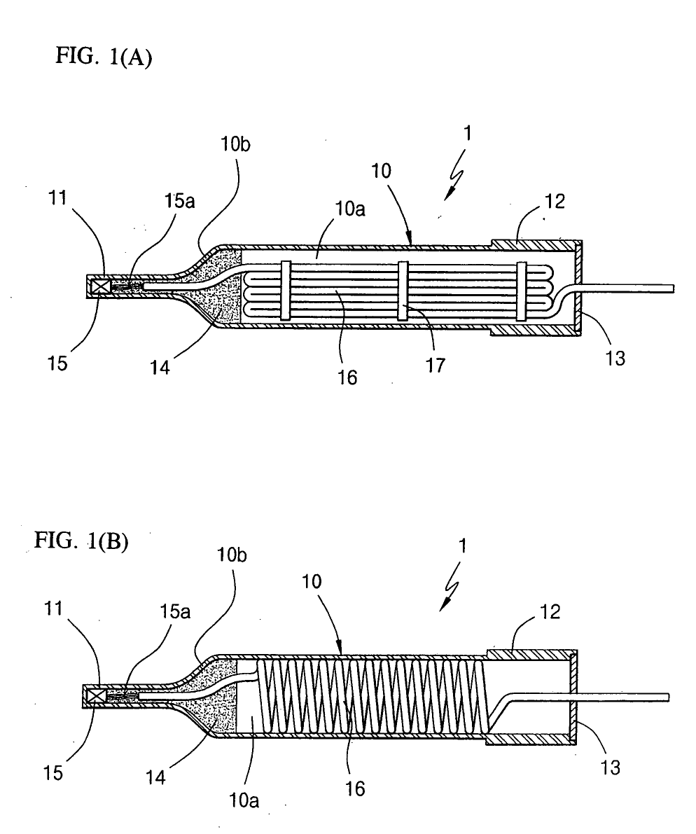

Hereinafter, the constitution and the operation of a sensor for measuring water temperature according to the preferred embodiments of the present invention will be explained in more detail with reference to the accompanying drawings FIGS. 1A to 4.

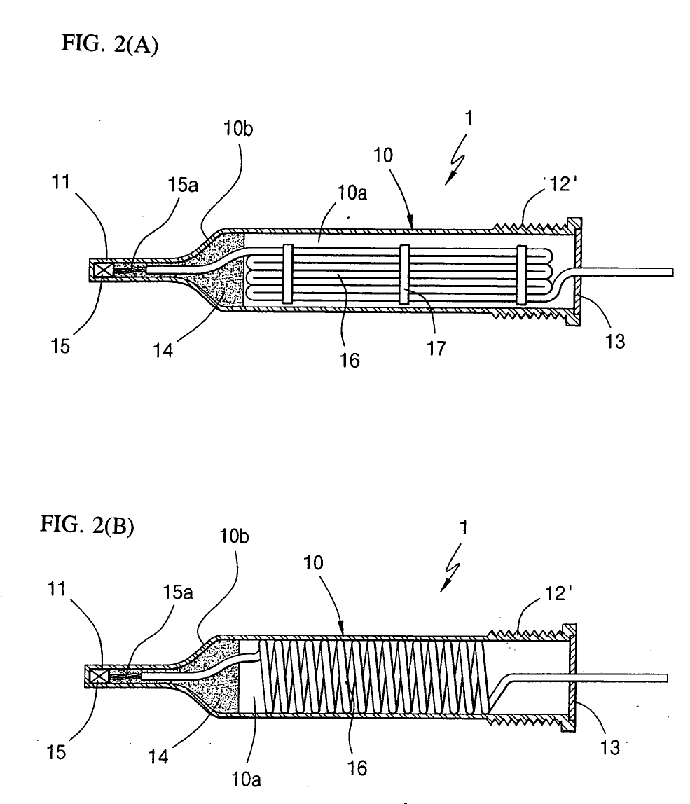

FIGS. 1A and 1B are side sectional views of a sensor for measuring water temperature according to the preferred first embodiment of the present invention, and FIGS. 2A and 2B are side sectional views of a sensor for measuring water temperature according to the preferred second embodiment of the present invention.

As shown in FIGS. 1A and 1B, the sensor 1 for measuring water temperature according to the preferred first embodiment of the present invention includes a water temperature sensing part 11 formed at a front portion of a case 10 having a pipe-shaped body, and an engaging portion 12 for fixedly engaging the sensor 1 with a variety of devices requiring the measurement of water temperature protrudes from a rear circumferential edge of the case 10.

A temperature-sensing sensor 15 is installed in the water temperature sensing part 11. The temperature-sensing sensor 15 is connected to a lead wire 16 via an electric wire 15a. A rear cover 13 is fitted into a rear opening of the case 10. A rear terminal portion of the lead wire 16 extends through the rear cover 13 to the outside of the case 10.

A slanted shoulder portion 10b projects from the front portion of the case 10 to the water temperature sensing part 11. The water temperature sensing part 11 projects from the shoulder portion 10 toward the front portion of the case 10 and has a diameter smaller than that of the pipe-shaped body. A lead wire inserting space 10a is formed at the rear portion of the case 10. The temperature-sensing sensor 15 is fixedly installed in the water temperature sensing part 11 by means of a filing material 14 charged between the water temperature sensing part 11 and the shoulder portion 10b.

The water temperature sensing part 11 projects from the shoulder portion 10b toward the front side of the case 10 and has a diameter smaller than that of the pipe-shaped body. The filing material 14 charged between the temperature sensing part 11 and the shoulder portion 10b primarily protects the temperature-sensing sensor 15 inserted into the water temperature sensing part 11. The filing material 14 allows the temperature-sensing sensor 15 to rapidly sense the water temperature and prevents the temperature-sensing sensor 15 from being contacted with the moisture. The filing material 14 has a resistance to the moisture and may be easily shaped as various shapes. If some materials such as a stainless steel or an acrylonitrile butadiene styrene resin and so on have an excellent thermal conductivity, there is no objection to use these materials as the filing material 14 in the case 10. It is preferred to use a transparent synthetic resin (=plastic) so that a user easily ascertains the insertion state of the temperature-sensing sensor 15 into the water temperature sensing part 11 formed at the front part of the case 10 and also the insertion state of the lead wire 16 into the piped-shaped body.

The temperature-sensing sensor 15 to be connected with the lead wire 16 via the electric wire 15a is fixedly installed in the water temperature sensing part 11 by means of the filing material 14. The filing material 14 for fixing the temperature-sensing sensor 15 allows the temperature-sensing sensor 15 and the electric wire 15a to easily be deposited together with the lead wire 16 under an initial liquid state such as an epoxy resin. Even though any additional hardener is not used, the filing material 14 easily becomes hard together with parts that are deposited into the filing material under the room temperature. If some materials have an excellent mechanical property and an excellent electrical insulating property and do not generate any volatile material during hardening of them, there is no objection to use these materials as the filing material in the case 10.

In addition, the filing material 14 removes any space between the temperature-sensing sensor 15 and the water temperature sensing part 11 so as to rapidly transmit water temperature from the outside of the sensor through the temperature-sensing sensor 15. Furthermore, the filing material 14 shuts off double the penetration of moisture into the temperature-sensing sensor 15 together with the case 10 and protects the temperature-sensing sensor 15 and the connecting portion between the temperature-sensing sensor 15 and the lead wire 16, that is a part of the electric wire 15a, from various shocks applied to them. The depth of the filing material 14 depends upon the deposition of the temperature-sensing sensor 15 and the electric wire 15a into the filing material 14. In order to prevent circuit-short, it is preferred to deposit a part of the lead wire 16 in the filing material 14. If the filing material 14 is excessively charged into the water temperature sensing part 11, it takes much time to fully dry the filing material 14 and thereby the manufacturing time of the sensor becomes large.

The temperature-sensing sensor 15 is fixed in the water temperature sensing part 11 formed at the front end of the case 10 by means of the filing material 14 charged between the temperature-sensing sensor 15 and the shoulder portion 10b. The lead wire 16 is connected with the temperature-sensing sensor 15 via the electric wire 15a and extends toward the body of the case 10. The lead wire 16 has a length of 500˜1,000 mm. As shown in FIG. 1A, the lead wire 16 is tied by using a binding member 17 such as a tie or a wire in a zigzag manner. Under this state, the lead wire 16 may be inserted into the lead wire inserting space 10a that is provided in the case 10. Alternatively, as shown in FIG. 1B, the lead wire 16 may be wound along the interior of the body of the case 10 in a spiral manner. One end of the lead wire 16 inserted into the lead wire inserting space 10a extends to the outside through the rear cover 13 of the case 10 and then it may be connected with a water temperature displaying unit (not shown) or various control devices (not shown).

By disposing the lead wire 16 in the case 10 either in a zigzag manner or in a spiral manner, the total length of the lead wire 16 charged into the case 10 becomes large at about 500˜1,000 mm. As a result, it is possible to delay the transmission of the external temperature to the temperature-sensing sensor 15 along the lead wire 16 while the external temperature transmitted along the lead wire 16 in the lead wire inserting space 10a may be incorporated to the internal temperature of the device or may be exhausted to the outside. Accordingly, the external temperature cannot directly affect to the temperature-sensing sensor 15 and it is possible to minimize the volume that is occupied by the lead wire 16. If the lead wire 16 having a length of about 500˜1,000 mm can be inserted into the body of the case 10, there is no limit to employ any insertion structure such as a zigzag manner or a spiral manner. It will be appreciated that while a particular embodiment of the invention has been shown and described, modifications may be made.

FIGS. 2A and 2B are side sectional views of a sensor for measuring water temperature according to the preferred second embodiment of the present invention.

Prior to proceeding to the more detailed description of the instant invention, it should be noted that, for the sake of clarity and understanding of the invention identical components which have identical functions have been identified with identical reference numerals through the different views, which are illustrated in each of the attached, drawing Figures.

The technical constitution of the water temperature-sensing sensor 1 is the same as that of the first preferred embodiment of the present invention as described above, except for a screw-thread connecting portion 12′.

In the first preferred embodiment of the present invention, the engaging portion 12 is formed at the rear circumferential edge of the case 10 so as to fit the case 10 into other experimental equipments. Alternatively, in the second preferred embodiment of the present invention, the case 10 can be threadly engaged with other experimental equipments through the screw-thread connecting portion 12′.

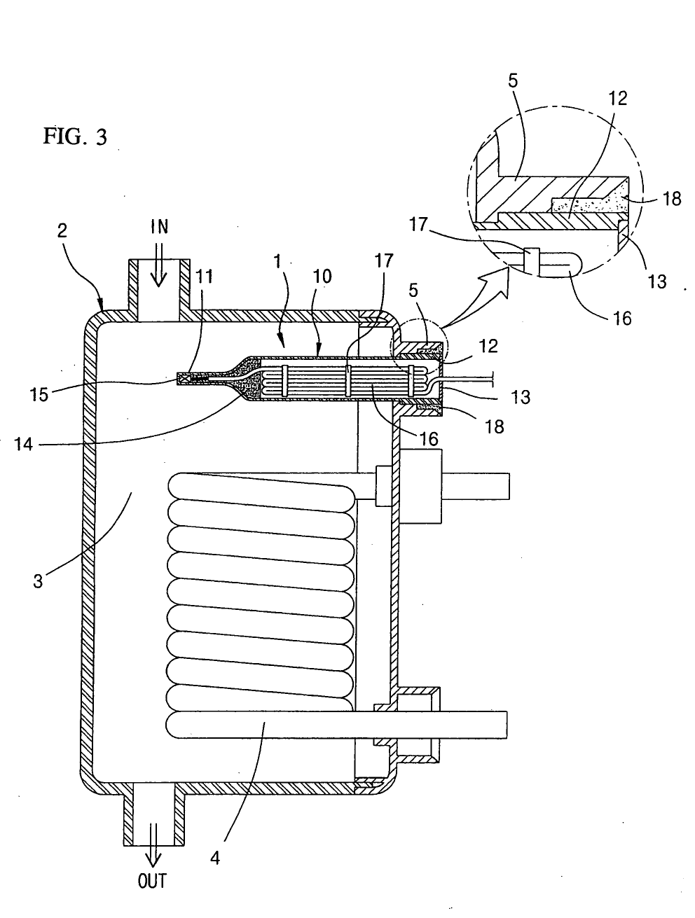

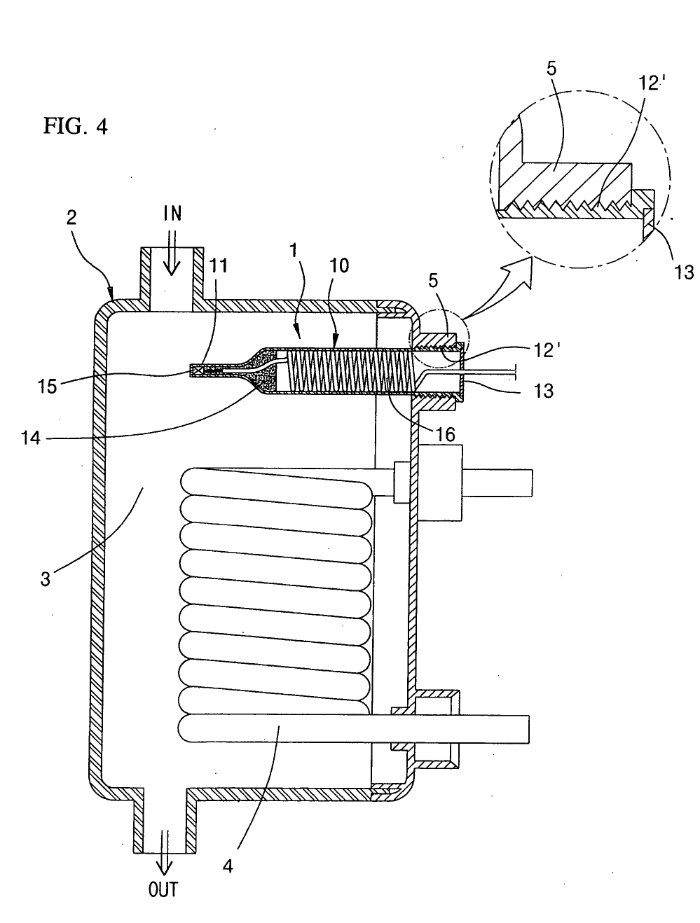

Hereinafter, the installation and the operation of the water temperature sensing part according to the present invention will be explained in more detail with reference to FIGS. 3 and 4.

Although following description relates to the constitution that the water temperature-sensing sensor is used for measuring the temperature of the fluid stored in a heat exchanger tank, it is possible to install and use the water temperature-sensing sensor according to the present invention regardless of kinds of the devices requiring the measurement of the fluid's temperature.

As best seen in FIG. 3, the lead wire 16 is disposed in the case 10 in a zigzag manner and an engaging portion 12 is formed at a rear circumferential edge of the case 10. The water temperature-sensing sensor having the lead wire 16 and the engaging portion 12 is inserted into a heat exchanger tank 3 through a sensor-inserting portion 5 formed at a wall surface of a heat exchanger 2. A packing member 18 for preventing a leak of water is formed between the engaging portion 12 and the sensor-inserting portion 5.

As best seen in FIG. 4, the lead wire 16 is disposed in the case 10 at a zigzag manner and a screw-thread connecting portion 12′ is formed at a rear circumferential portion of the case 10. The water temperature-sensing sensor having the lead wire 16 and the screw-thread connecting portion 12′ is inserted into the heat exchanger tank 3 through the sensor-inserting portion 5 formed at a wall surface of a heat exchanger 2. A screw portion may be formed at an inner peripheral surface of the sensor-inserting portion 5 so as to engage the case 10 therein. During the engagement of the case 10, a packing for preventing a leak of water may be applied to an engaging surface between the sensor-inserting portion 5 and the screw-thread connecting portion 12′ and an O-shaped ring for preventing a leak of water may be disposed between the screw-thread connecting portion 12′ and the sensor-inserting portion 5.

As described above, the water temperature-sensing sensor according to the present invention is inserted into the heat exchanger tank 3 the lead wire 16 extending through the rear cover 13 of the case 10 is connected with the water temperature-displaying device (not shown) or any controller (not shown). And then a gaseous heat exchanging fluid or a liquid heat exchanging fluid may flow through the heat exchange pipe 4 installed in the heat exchanger 2. As a result, the temperature of the fluid stored in the heat exchanger tank 3 may be changed due to the heat exchange with the heat exchanging fluid. Then, the water temperature-sensing sensor according to the present invention senses this fact and then it displays a corresponding temperature on the water temperature-displaying device and then it sends a signal to the controller so as to automatically control the heat exchanger 2.

If a difference between the temperature of the fluid stored in the heat exchanger tank 3 and the external temperature of the heat exchanger 2 becomes large during the use of the water temperature-sensing sensor, the external temperature may be transmitted to the temperature-sensing sensor 15 via the lead wire 16. At this time, since the lead wire 16 having the total length of about 500˜1,000 mm is disposed in the case either in a zigzag manner or in a spiral manner, it is possible to delay the time interval of external temperature transmitted to the temperature-sensing sensor 15 along the lead wire 16. The lead wire inserting space 10a of the case 10 is corresponding to the temperature of the fluid stored in the heat exchanger tank 3. When the external temperature is transmitted into the case 10 along the lead wire 16, it is incorporated into the internal temperature of the lead wire inserting space 10a of the case 10, which is the temperature of the fluid stored in the heat exchanger tank 3. Accordingly, the external temperature cannot affect to the temperature-sensing sensor 15. Since the fluid stored in the heat exchanger tank 3 cannot be contacted with the temperature-sensing sensor 15 that is protected by the case 10 and the filing material 14, there is no erroneous operation of the temperature-sensing sensor 15 due to the contact with the moisture. Accordingly, it is possible to perform the measurement of fluid's temperature by using the temperature-sensing sensor 15.

Consequently, it is possible to enhance the reliability of the device for measuring the water temperature or the heat exchanger 2 as described above. When any shock or vibration is applied to a device such as the heat exchanger 2 during the use of the water temperature-sensing sensor, the connecting portion between the temperature-sensing sensor 15 and the electric wire 15a sufficiently endures the shock due to operation of the filing material 14. Accordingly, it is possible to minimize the erroneous operation of the temperature-sensing sensor 15. Due to this, it is possible to efficiently and safely use various devices requiring the measurement of the fluid's temperature.

Since the water temperature sensing part 11 is disposed in the front part of the case 10 of which the front part becomes narrow and narrow from the body of the case, the temperature-sensing sensor 15 may be safely inserted into the case 10 through the front part of the water temperature sensing part 11 so that there is no circuit-short. Since the sensor may be manufactured in a state that the temperature-sensing sensor 15, the electric wire 15a and the lead wire 16 are integrally disposed and fixed in the filing material 14, it is possible to save time and expense for producing the water temperature-sensing sensor and thereby the productivity of the sensor is highly enhanced.

While the present invention has been shown and described with reference to a particular embodiment thereof, it will be understood by those skilled in the art that various changes in form and detail may be effected therein without departing from the spirit and scope of the invention as defined by the appended claims.

1. A sensor for measuring water temperature, comprising a case having a pipe shaped body and a front portion, a water temperature sensing part formed at said front portion of said case, an engaging portion protruding from a rear circumferential edge of the case, a temperature-sensing sensor installed in the water temperature sensing part and connected with a lead wire via an electric wire, a rear terminal portion of the lead wire extending through a rear cover to the outside of the case, a slanted shoulder portion projecting from the front portion of the case to the temperature sensing part, the temperature sensing part projecting from the shoulder portion toward the front portion of the case and having a predetermined diameter smaller than that of the pipe-shaped body of the case, said temperature-sensing sensor being fixedly installed in the water temperature sensing part by means of a filing material 14 between the temperature sensing part and the shoulder portion, wherein a lead wire inserting space is created at the rear portion of the pipe-shaped body of the case, in which the lead wire to be connected with the temperature-sensing sensor is arranged in the lead wire inserting space in a tortuous manner.

2. The sensor for measuring water temperature, according to claim 1 wherein the engaging portion of the case comprises a screw-thread connecting portion.

3. A sensor for measuring water temperature according to claim 1 wherein said lead wire has a length of 500-1000 mm.

4. A sensor for measuring water temperature according to claim 1 wherein said tortuous path is a zigzag path.

5. A sensor for measuring water temperature according to claim 1 wherein said tortuous path is a spiral path.
